(19) United States
(12) Patent Application Publication
(10) Pub. No.: US 2025/0246716 A1
(43) Pub. Date: Jul. 31, 2025

(54) TRACTION BATTERY PACK THERMAL MANAGEMENT FLUID GUIDING SYSTEM AND METHOD OF GUIDING THERMAL MANAGEMENT FLUID

(71) Applicant: Ford Global Technologies, LLC, Dearborn, MI (US)

(72) Inventor: Brad Alan VanDerWege, Plymouth, MI (US)

(21) Appl. No.: 18/424,931

(22) Filed: Jan. 29, 2024

(51) Int. Cl. H01M 10/6567; B60L 50/60; H01M 10/613; H01M 10/625; H01M 10/658; H01M 50/209; H01M 50/342; H01M 50/507

(52) U.S. Cl. CPC H01M 10/6567; H01M 10/613; H01M 10/625; H01M 10/658; H01M 50/209; H01M 50/3425; H01M 50/507; B60L 50/60; H01M 2220/20

(57) ABSTRACT

A traction battery pack assembly including an enclosure, a cell stack within an interior of the enclosure. The cell stack includes a plurality of battery cells disposed along a cell stack axis. Each of the battery cells has a vent. A plurality of standoffs support the cell stack within the enclosure. The plurality of standoffs are configured to guide a liquid coolant of an immersion thermal management system within the interior. The plurality of standoffs are disposed along the cell stack axis at positions that are axially misaligned with the vents.

### TECHNICAL FIELD

This disclosure details exemplary systems that guide liquid coolant within a battery pack and, more particularly, to a system that guides the liquid coolant between cells of a cell stack.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a traction battery pack assembly, including: an enclosure; a cell stack within an interior of the enclosure, the cell stack including a plurality of battery cells disposed along a cell stack axis, each of the battery cells having a vent; and a plurality of standoffs supporting the cell stack within the enclosure, the plurality of standoffs configured to guide a liquid coolant of an immersion thermal management system within the interior, the plurality of standoffs disposed along the cell stack axis at positions that are axially misaligned with the vents.

In some aspects, the techniques described herein relate to an assembly, wherein the plurality of standoffs are a plurality of ribs projecting into the interior.

In some aspects, the techniques described herein relate to an assembly, wherein the plurality of standoffs directly contact the plurality of battery cells.

In some aspects, the techniques described herein relate to an assembly, wherein a distance between axially adjacent standoffs establishing channels that receive thermal barriers is less than a distance between axially adjacent standoffs establishing channels that do not receive thermal barriers.

In some aspects, the techniques described herein relate to an assembly, wherein the plurality of standoffs contact the plurality of battery cells on a first axial side of the vents or on an opposite, second axial side of the vents.

In some aspects, the techniques described herein relate to an assembly, wherein the cell stack is disposed vertically between some of the plurality of standoffs that are above the cells and some of the plurality of standoffs that are beneath the cells.

In some aspects, the techniques described herein relate to an assembly, wherein the vents are configured to release vent byproducts to an area that is axially between two of the standoffs that are axially adjacent to each other.

In some aspects, the techniques described herein relate to an assembly, wherein the standoffs guide coolant along a vertical top of the cell stack and along a vertical bottom of the cell stack.

In some aspects, the techniques described herein relate to an assembly, wherein the cell stack includes a plurality of thermal barriers disposed along the cell stack axis between groups of one or more of the battery cells, the plurality of thermal barriers projecting outward from the cell stack axis past the battery cells.

In some aspects, the techniques described herein relate to an assembly, wherein the plurality of thermal barriers extend outward past the battery cells to overlap with at least some of the standoffs.

In some aspects, the techniques described herein relate to an assembly, wherein the plurality of thermal barriers extend outward to a position axially between a first standoff within the plurality of standoffs, and a second standoff within the plurality of standoffs, the second standoff directly adjacent to the first standoff on a first axial side of the first standoffs, wherein an axial distance between the first standoff and the second standoffs is less than an axial distance between the first standoff and third standoff that is directly adjacent to the first standoff on an opposite, second axial side of the first standoff.

In some aspects, the techniques described herein relate to an assembly, wherein an axial distance between pairs of the standoffs that are positioned axially next to the thermal barriers is less than an axial distance between pairs of the standoffs that are not positioned axially next to the thermal barriers.

In some aspects, the techniques described herein relate to an assembly, wherein the thermal barriers extend vertically above the battery cells and vertically beneath the battery cells.

In some aspects, the techniques described herein relate to an assembly, further including a busbar frame assembly disposed along a lateral side of the cell stack, the busbar frame holding at least one busbar that is electrically connected to one or more terminals of the battery cells within the cell stack, the thermal barriers extending laterally outward past the battery cells at least as far as the busbar frame.

In some aspects, the techniques described herein relate to an assembly, wherein the plurality of thermal barriers each extend laterally outward into respective gaps within the busbar frame assembly.

In some aspects, the techniques described herein relate to an assembly, wherein the cell stack is one of a plurality of cell stacks within the interior.

In some aspects, the techniques described herein relate to a method of guiding liquid coolant within a traction battery pack, including: supporting a cell stack on a plurality of standoffs within an enclosure; using the plurality of standoffs to guide a liquid coolant an immersion thermal management system to manage thermal energy within the cell stack, the cell stack including a plurality of battery cells disposed along a cell stack axis; and offsetting the plurality of standoffs axially from any vents of the plurality of battery cells.

In some aspects, the techniques described herein relate to a method, further including extending a thermal barrier of the cell stack outward past the plurality of battery cells to overlap with the plurality of battery cells.

In some aspects, the techniques described herein relate to a method, wherein some of the plurality of standoffs support the cell stack from below the cell stack, and some of the plurality of standoffs support the cell stack from above the cell stack.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of the battery pack of FIG. 1 along with a cover of an enclosure removed to reveal components within an interior of the enclosure.

FIG. 3 illustrates a perspective, bottom view of a battery cell from the battery pack of FIG. 2.

FIG. 4 is a section view taken at line 4-4 in FIG. 2.

FIG. 5 is a section view taken at line 5-5 in FIG. 2.

FIG. 6 is a section view taken at line 6-6 in FIG. 2.

### DETAILED DESCRIPTION

An immersion thermal management system can be used to manage thermal energy in a traction battery pack. The immersion thermal management system immerses at least some components of the traction battery pack in a liquid coolant. The immersed components can include a cell stack. This disclosure is directed toward guiding the liquid coolant using a using standoffs that support the cell stack and, more particularly to how the standoffs are positioned within the battery pack.

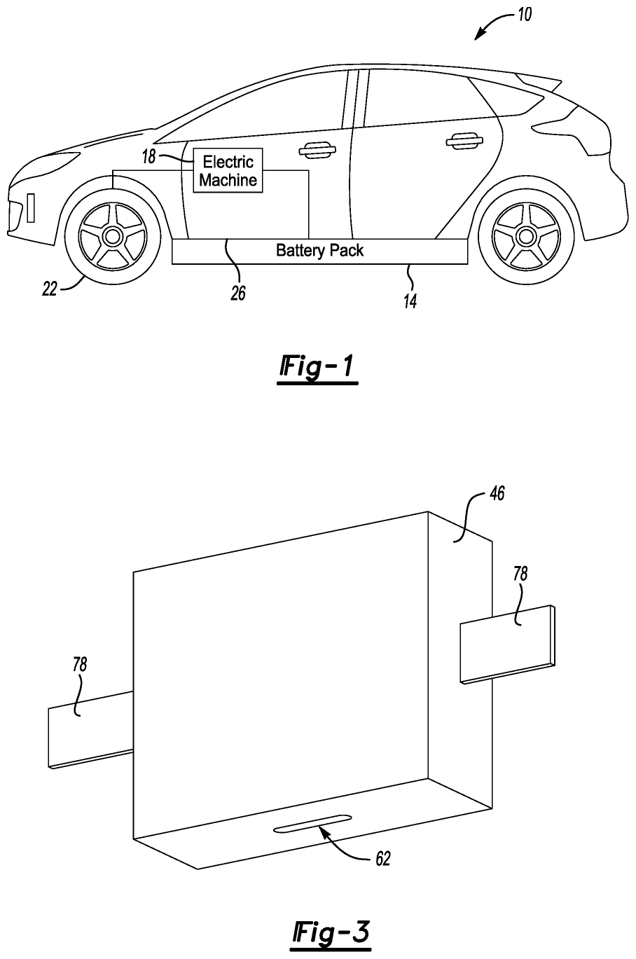

With reference to FIG. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

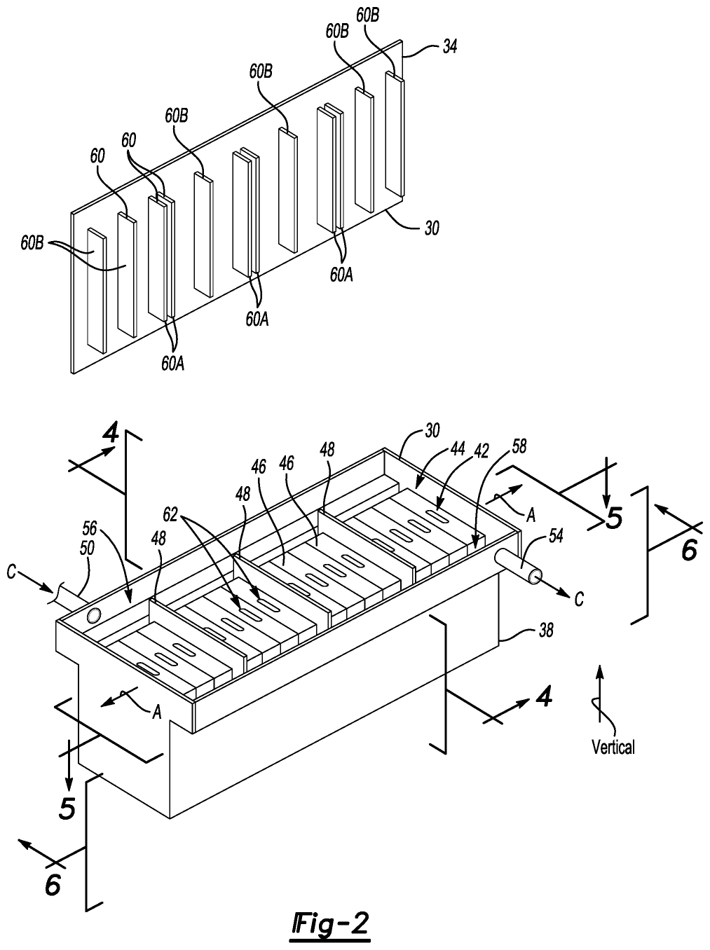

FIGS. 2 to 6 illustrate additional detail of the example battery pack 14. In this example, the battery pack 14 includes an enclosure assembly 30. The enclosure assembly 30 includes a cover 34 and a tray 38. The cover 34, in this example, is vertically above the tray 38. In other examples, however, the cover 34 could be arranged below, or to a side of the tray 38. Various terms such as “above,” “below,” “top,” and “bottom” are used relative to the arrangement of the components of the battery pack 14 in the various drawings and should not otherwise be deemed limiting. These terms are with reference to the general orientation of the battery pack 14 when installed within the vehicle 10 of FIG. 1. Vertical, for purposes of this disclosure, is also with reference to ground and how the battery pack 14 is oriented when installed within the vehicle.

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within an interior 44 of the enclosure assembly 30. The cell stack 42 includes a plurality of individual battery cells 46 disposed along a cell stack axis A along with thermal barriers 48. In this example, groups of four individual battery cells 46 are separated by thermal barriers 48 along the axis A. The cell stack 42 could include any number of battery cells 46 and groups of other numbers of individual battery cells 46 could be utilized in other examples. In some examples, the groups include single battery cells 46 separated from each other along the axis A by the thermal barriers 48.

While the example battery pack 14 includes one cell stack 42, other examples could employ any number of cell stacks 42 within the enclosure assembly 30. Thus, this disclosure is not limited to the exact configuration shown in FIG. 2.

In an embodiment, the battery cells 46 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The cell stack 42 is arranged within interior 44 the enclosure assembly 30 within the tray 38 and beneath the cover 34. A thermal management system is used to manage thermal energy levels within the battery pack 14. The example thermal management system is configured to route non-conductive (i.e., dielectric) coolant C over areas of the cell stack 42 to manage thermal energy within the cell stack 42 by, for example, using the coolant C to take on heat from the cell stack 42.

The thermal management system is an immersion thermal management system at least because portions of the battery pack 14, here at least the battery cells 46 of the cell stack 42 are immersed in the coolant C. Thermal energy can transfer between the coolant C and the cells 46 as the coolant C moves between the cells 46. The coolant helps to manage thermal energy of the battery cells 46 as well as other components of the battery pack 14.

In this example, the coolant C is delivered to the battery pack 14 through an inlet 50. The coolant C moves from the battery pack 14 through an outlet 54, which is at an opposite end of the enclosure assembly 30 from the inlet 50. The coolant C can be cooled outside the battery pack 14 and then recirculated through the inlet 50.

The inlet 50 and the outlet 54 are disposed near a vertical top of the battery pack 14. This positioning can facilitate filling the interior 44 with the coolant C as air can escape as a level of the coolant C continues to rise during filling.

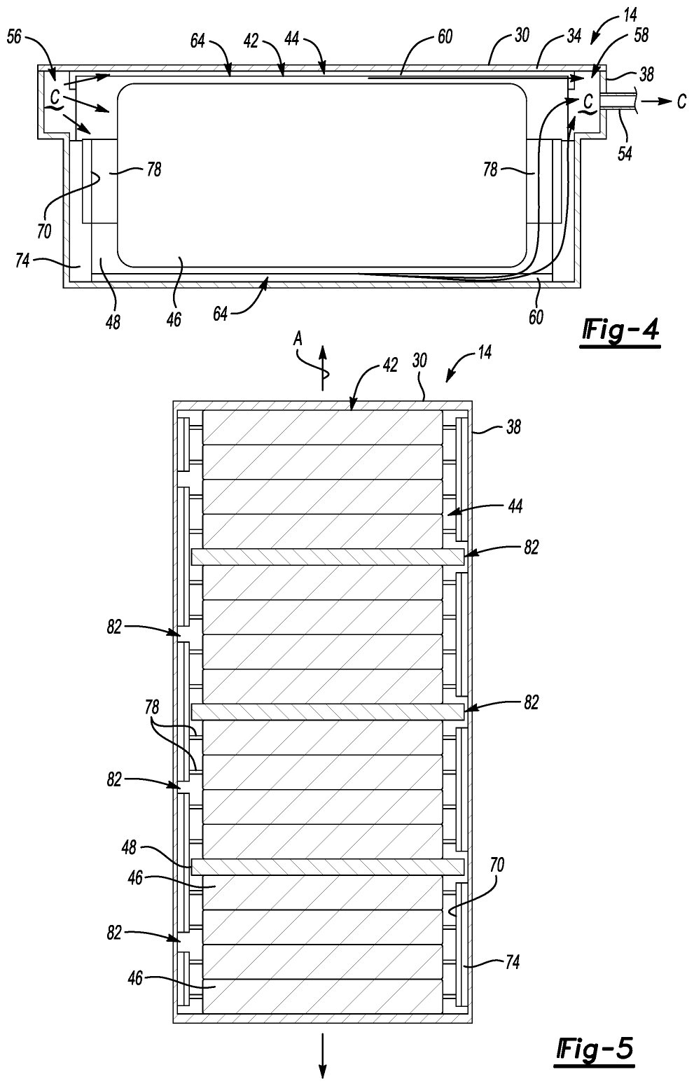

The example enclosure assembly 30 includes an inlet manifold 56, which is a laterally bumped-out area of the enclosure assembly 30. The inlet manifold 56 receives the coolant C from the inlet 50. The inlet manifold 56 extends axially along a length of the battery pack 14. Coolant C can move axially within the inlet manifold and then move from the inlet manifold 56 vertically downward along a lateral side of the cell stack 42 and over the top of the cell stack 42 (FIG. 4). The inlet manifold 56 can guide the coolant C axially within the enclosure assembly 30.

The enclosure assembly 30 includes an outlet manifold 58 that receives coolant C that has moved adjacent to the cell stack 42. The outlet manifold 58 extends axially along a length of the battery pack 14. The outlet manifold 58 can guide the coolant C axially within the enclosure assembly 30 toward the outlet 54.

A plurality of standoffs 60 support the cell stack 42 within the enclosure. The example standoffs 60 are ribs or flanges that project into the interior 44. The standoffs 60 directly contact the battery cells 46 and, more particularly, outer cases of the battery cells 46 in this example. In other examples, a layer of adhesive and/or damping material may be disposed between the stand-offs and the battery cells 46. Some of the standoffs 60 extend downward from the cover 34 to the battery cells 46 of the cell stack 42. Some of the standoffs 60 extend upward from a floor of the tray 38 to the battery cells 46 of the cell stack 42. Thus, in this example, the cells 46 are disposed vertically between standoffs 60.

The standoffs 60 establish flow channels 64 that are used to communicate coolant C along a vertical top of the cell stack 42 and along a vertical bottom of the cell stack 42

From time to time, pressure and thermal energy within one or more of the battery cells 46 can increase. The pressure and thermal energy increase can be due to an overcharge condition, for example. The pressure and thermal energy increase can cause the associated battery cell 46 to rupture and expel vent byproducts, such as gas and debris, from within the battery cell 46. The vent byproducts can be released from the associated battery cell 46 through a designated vent 62, such as a membrane that yields in response to increased pressure, or through a vent established through a ruptured area of the associated battery cell 46. Pouch cells, for example, may not include a dedicated vent location, but vent through ruptured areas.

The example battery cells 46 each include vents 62 that open through top sides of the battery cells 46, other vents 62 open through the bottom sides of the battery cells 46. As the example cell stack 42 is immersion cooled, the vent byproducts move directly into the coolant C that is within one of the flow channels 64.

The vent byproducts can have relatively high thermal energy levels. Guiding the vent byproducts away from other battery cells 46 that are not venting-especially in areas near the vent 62 that has ruptured where thermal energy in the vent byproducts is relatively high—can prevent those battery cells 46 from venting and leading to a thermal event cascading to other battery cells 46.

To block movement of the vent byproducts along the cell stack axis A, the standoffs 60 are disposed along the cell stack axis A at positions that are axially misaligned with the vents 68 of the battery cells 46. The positioning offsets the standoffs 60 from the vents 68. This positioning with the battery pack 14 configures the vent 62 to release vent byproducts into one of the flow channels 64, which is the area that is between two of the standoffs 60 that are axially adjacent to each other. The standoffs 60 axially adjacent to the vent 62 that is releasing vent byproducts force the vent byproducts to move with the coolant C laterally outward rather than axially. Movement of the vent byproducts axially could introduce thermal energy to other groups of battery cells 46 with the cells stack-groups of battery cells 46 that are not venting.

Releasing the vent byproducts between standoffs 60 helps to contain thermal energy associated with the vent byproducts to a single group of the battery cells 46 rather than permitting the vent byproducts V to move axially to another group of the battery cells 46. If, for example, one of the standoffs 60 was axially aligned with one of the vents 68, vent byproducts released from that vent 68 could potentially move to both axial sides of the standoff 60 rather than be confined to a single axial side of the standoff 60.

The thermal barriers 48 also help to block vent byproducts released from one of the groups of battery cells 46 from moving adjacent to another of the groups of battery cells 46. In particular, the thermal barriers 48 project outward from the cell stack axis A past the battery cells 46. In this example, the thermal barriers 48 extend vertically above the battery cells 46, laterally past the battery cells 46 on both sides, and vertically below the battery cells 46. The thermal barriers 48 extend vertically upward into one of the flow channels 64. The thermal barriers 48 overlap with the standoffs 60 that are above the battery cells 46. The thermal barriers 48 extend vertically downward into one of the flow channels 64 beneath the battery cells 46 to overlap with the standoffs 60 that are below the battery cells 46.

Some of the standoffs 60A are directly adjacent to the thermal barriers 48 along the cell stack axis A. The remaining standoffs 60B are not directly adjacent to the thermal barriers 48 (i.e., one or more of the standoffs 60A is axially between the standoffs 60B and the thermal barrier 48).

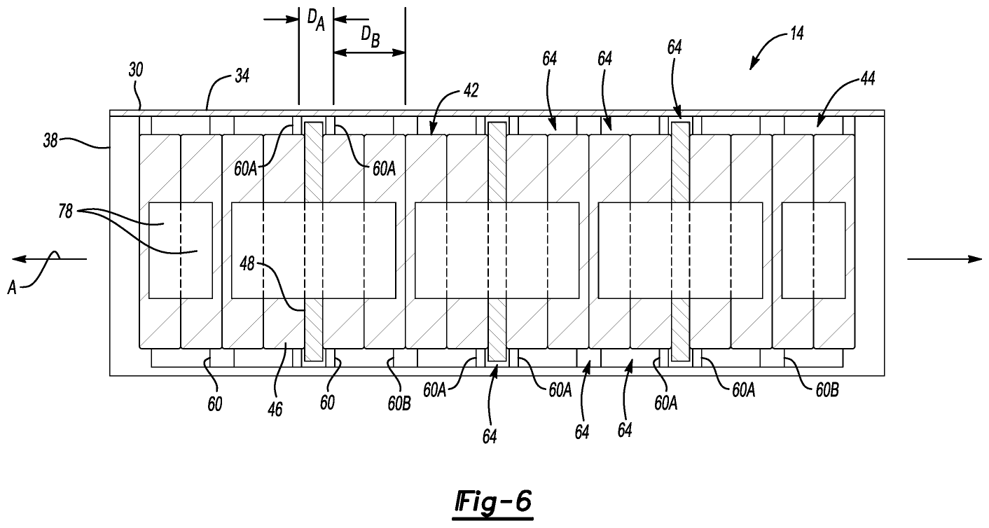

The thermal barriers 48 are disposed between pairs of the standoffs 60A. A distance DA between these standoffs 60A is less than a distance DB between pairs of the standoffs 60 (FIG. 6). Thus, an axial distance between pairs of the standoffs 60A that are positioned axially next to the thermal barriers 48 is less than an axial distance between pairs of the standoffs 60B that are not positioned axially next to the thermal barriers 48. This spacing locates the standoffs 60A at axial ends of the groups of battery cells 46 and away from vents 62. The flow channels 64 that receive the thermal barriers 48 are thus narrower than the flow channels 64 that do not receive the thermal barriers 48.

The battery pack 14 includes busbars 70 held by busbar frames 74. The busbars 70 and busbar frames 74 are disposed along opposing lateral sides of the cell stack 42 within the enclosure assembly 30. Tab terminals 78 of the battery cells 46 extend laterally outward to electrically connect to the busbars 70. The busbar frames 74 can be a polymer-based material.

The thermal barriers 48 extend laterally outward past the battery cells 46 at least as far as the busbar frame 74. In this example, the busbar frames 74 include gaps 82 (FIG. 5), and the thermal barriers 48 extends laterally outward into the gaps 82.

Extending the thermal barriers 48 into this gaps 82 and into areas between the standoffs 60 can help to block vent byproducts V released into the coolant C from moving axially. After vent byproducts V are released into the coolant C, the vent byproducts are directed outward into the outlet manifold 58. Within the outlet manifold 58, the vent byproducts V can be moved axially with the coolant C. Within the outlet manifold 58, the vent byproducts V are spaced further from battery cells 46 and less likely to increase a temperature of battery cells 46 that are not venting.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure;
a cell stack within an interior of the enclosure, the cell stack including a plurality of battery cells disposed along a cell stack axis, each of the battery cells having a vent; and
a plurality of standoffs supporting the cell stack within the enclosure, the plurality of standoffs configured to guide a liquid coolant of an immersion thermal management system within the interior, the plurality of standoffs disposed along the cell stack axis at positions that are axially misaligned with the vents.

2. The assembly of claim 1, wherein the plurality of standoffs are a plurality of ribs projecting into the interior.

3. The assembly of claim 1, wherein the plurality of standoffs directly contact the plurality of battery cells.

4. The assembly of claim 1, wherein a distance between axially adjacent standoffs establishing channels that receive thermal barriers is less than a distance between axially adjacent standoffs establishing channels that do not receive thermal barriers.

5. The assembly of claim 1, wherein the plurality of standoffs contact the plurality of battery cells on a first axial side of the vents or on an opposite, second axial side of the vents.

6. The assembly of claim 1, wherein the cell stack is disposed vertically between some of the plurality of standoffs that are above the cells and some of the plurality of standoffs that are beneath the cells.

7. The assembly of claim 1, wherein the vents are configured to release vent byproducts to an area that is axially between two of the standoffs that are axially adjacent to each other.

8. The assembly of claim 1, wherein the standoffs guide coolant along a vertical top of the cell stack and along a vertical bottom of the cell stack.

9. The assembly of claim 1, wherein the cell stack includes a plurality of thermal barriers disposed along the cell stack axis between groups of one or more of the battery cells, the plurality of thermal barriers projecting outward from the cell stack axis past the battery cells.

10. The assembly of claim 9, wherein the plurality of thermal barriers extend outward past the battery cells to overlap with at least some of the standoffs.

11. The assembly of claim 10, wherein the plurality of thermal barriers extend outward to a position axially between a first standoff within the plurality of standoffs, and a second standoff within the plurality of standoffs, the second standoff directly adjacent to the first standoff on a first axial side of the first standoffs, wherein an axial distance between the first standoff and the second standoffs is less than an axial distance between the first standoff and third standoff that is directly adjacent to the first standoff on an opposite, second axial side of the first standoff.

12. The assembly of claim 9, wherein an axial distance between pairs of the standoffs that are positioned axially next to the thermal barriers is less than an axial distance between pairs of the standoffs that are not positioned axially next to the thermal barriers.

13. The assembly of claim 9, wherein the thermal barriers extend vertically above the battery cells and vertically beneath the battery cells.

14. The assembly of claim 9, further comprising a busbar frame assembly disposed along a lateral side of the cell stack, the busbar frame holding at least one busbar that is electrically connected to one or more terminals of the battery cells within the cell stack, the thermal barriers extending laterally outward past the battery cells at least as far as the busbar frame.

15. The assembly of claim 14, wherein the plurality of thermal barriers each extend laterally outward into respective gaps within the busbar frame assembly.

16. The assembly of claim 1, wherein the cell stack is one of a plurality of cell stacks within the interior.

17. A method of guiding liquid coolant within a traction battery pack, comprising:
supporting a cell stack on a plurality of standoffs within an enclosure;
using the plurality of standoffs to guide a liquid coolant an immersion thermal management system to manage thermal energy within the cell stack, the cell stack including a plurality of battery cells disposed along a cell stack axis; and
offsetting the plurality of standoffs axially from any vents of the plurality of battery cells.

18. The method of claim 17, further comprising extending a thermal barrier of the cell stack outward past the plurality of battery cells to overlap with the plurality of battery cells.

19. The method of claim 17, wherein some of the plurality of standoffs support the cell stack from below the cell stack, and some of the plurality of standoffs support the cell stack from above the cell stack.
